(19) United States
(12) Patent Application Publication
(10) Pub. No.: US 2026/0078683 A1
(43) Pub. Date: Mar. 19, 2026

(54) GUIDE VANE FOR ATTACHMENT TO A STATOR SHROUD OF A GAS TURBINE ENGINE, GAS TURBINE ENGINE STATOR ASSEMBLY AND GAS TURBINE ENGINE

(71) Applicant: SAFRAN, PARIS (FR)

(72) Inventors: William Henri Joseph RIERA, MOISSY-CRAMAYEL (FR); Simon Pierre Michel MARTIN, MOISSY-CRAMAYEL (FR)

(73) Assignee: SAFRAN, PARIS (FR)

(21) Appl. No.: 19/109,912

(22) PCT Filed: Sep. 8, 2023
(86) PCT No.: PCT/FR2023/051362

§ 371 Date: Mar. 7, 2025

(30) Foreign Application Priority Data
Sep. 9, 2022 (FR) FR2209065

(51) Int. Cl. F01D 9/04

(52) U.S. Cl. CPC F01D 9/042; F01D 9/041; F05D 2220/32; F05D 2240/12

(57) ABSTRACT

The invention relates to a guide vane for attachment to a stator shroud of a gas turbine engine, comprising:—a profiled part intended to extend in a gas flow in order to guide the gas flow, the profiled part having a pressure-side surface and a suction-side surface, and—a platform having a guide surface from which the profiled part extends, a first lateral surface and a second lateral surface, the second lateral surface being able to be arranged facing a first lateral surface of an identical adjacent guide vane, fanning a raised portion which prevents a parasitic transverse flow of the gas flow, while creating a depression which at least partially compensates for the obstruction of the gas flow by the raised portion.

### FIELD OF THE INVENTION

The invention concerns a guide vane intended to be fixed on a shroud of a stator of a gas turbine engine. The invention also concerns an assembly comprising a set of guide vanes and a gas turbine engine comprising such an assembly.

### STATE OF THE ART

Gas turbine engines generally comprise a fan section, a compressor section, a combustion chamber, and a turbine section.

The fan section, the compressor section, and the turbine section each comprise rotating parts (or “rotor”) and stationary parts (or “stator”).

For example, the fan section comprises a fan casing and a fan rotor capable of being driven in rotation relative to the fan casing. The fan rotor comprises one or more rows of blades. The rotation of the fan rotor has the effect of compressing air that is expelled backwards in order to produce part of the engine thrust.

Furthermore, the fan section generally comprises a set of Outlet Guide Vanes (OGV) disposed downstream of the fan rotor and acting as a straightener. This set of vanes has the function of straightening and regulating the air stream that flows downstream of the fan rotor to optimize the engine thrust. This set of vanes also plays a role of noise reducer.

The air stream that passes through the set of vanes generally flows between the vanes along an upstream-downstream direction. However, secondary aerodynamic flows may appear in the vicinity of the roots of the vanes.

Indeed, for each pair of vanes facing each other, a pressure gradient between the pressure surface (intrados surface) of a vane and the depression surface (extrados surface) of an adjacent vane generates a parasitic transverse flow that transports the air from the intrados surface to the extrados surface of the adjacent vane.

Moreover, at the vane tip, that is to say at the junction between the vane and the inner shroud of the casing or at the junction between the vane and the outer shroud of the casing, a corner separation and a corner vortex can occur. This separation generates pressure losses as well as aerodynamic blockage. Such aerodynamic blockage is problematic in terms of operability. For high incidences of the air stream arriving at the vanes, that is to say when the direction of air flow upstream of the vanes makes a significant angle with a direction of the leading edge of the vanes, this corner separation increases to the point of causing a detachment of the boundary layer on the aerodynamic part of the vane which can no longer ensure the flow deflection.

Other set of vanes of the engine are concerned by this phenomenon, in particular in the set of vanes of the straightener facing the sets of blades in the compressors or in the sets of vanes of the distributor facing the sets of blades in the turbines.

To overcome this problem, one solution consists in interposing between two adjacent vanes a fin whose function is to block the transverse stream of gas flowing from the intrados surface of a vane to the extrados surface of the adjacent vane. Document FR 3 106 614 describes one example of a fin.

However, a drawback of this solution is that it requires the manufacture and mounting of additional parts (fins).

It would also be possible to machine a fin directly in a platform of a vane. However, this would have the consequence of complicating the manufacture of the vanes.

### SUMMARY OF THE INVENTION

One aim of the invention is to propose a solution for blocking the parasitic flows in the sets of vanes, while limiting obstruction of the gas stream flow duct.

This problem is solved within the framework of the present invention by means of a guide vane intended to be fixed on a stator shroud of a gas turbine engine, comprising:
a profiled part intended to extend into a gas stream to guide the gas stream, the profiled part having an intrados surface and an extrados surface, and
a platform having a guide surface from which the profiled part extends, a first lateral surface and a second lateral surface, the second lateral surface being capable of being disposed facing a first lateral surface of an identical adjacent guide vane, such that the platform of the guide vane delimits with the platform of the adjacent guide vane a flow path for the gas stream flowing between the profiled part of the guide vane and the profiled part of the adjacent guide vane,
the guide surface comprising a first guide surface part extending from the intrados surface of the profiled part to the first lateral surface and a second guide surface part extending from the extrados surface of the profiled part to the second lateral surface, wherein a first junction line is formed at the intersection between the first guide surface part and the first lateral surface, a second junction line is formed at the intersection between the second guide surface part and the second lateral surface, a third junction line is formed at the intersection between the first guide surface part and the intrados surface, and a fourth junction line is formed at the intersection between the second guide surface part and the extrados surface,
the first guide surface part and the second guide surface part being configured such that when the guide vane is fixed to the shroud, the first junction line has a first radius measured from the central axis of the shroud in a plane transverse to the central axis, the second junction line has a second radius measured from the central axis, in the plane transverse to the central axis, the second radius being greater than the first radius, the third junction line has a third radius measured from the central axis, in the plane transverse to the central axis, and the fourth junction line has a fourth radius measured from the central axis in the plane transverse to the central axis, the fourth radius being less than or equal to the third radius.

The second radius greater than the first radius makes it possible to create a step (or a recess) between the second guide surface of the guide vane and the first guide surface of the adjacent guide vane, preventing parasitic circulation of part of the gas stream from the intrados surface of the guide vane to the extrados surface of the guide vane.

Thus, the second guide surface has an extra height relative to the first guide surface.

However, the fourth radius is kept less than or equal to the third radius. This makes it possible to generate a depression that compensates for the obstruction of the duct generated by the presence of the extra height.

The proposed guide vane may also have the following characteristics:
the first radius is equal to the third radius, and the fourth radius is smaller than the third radius;
a difference between the second radius and the first radius is equal to a difference between the third radius and the fourth radius;
the fourth radius is equal to the third radius;
a difference between the second radius and the fourth radius is equal to a difference between the third radius and the first radius;
the profiled part has a leading edge and a trailing edge, and the platform has a first transverse surface extending in a first transverse plane located upstream of the leading edge, and a second transverse surface extending in a second transverse plane located downstream of the trailing edge, the first junction line extending from the first transverse plane to the second transverse plane and the second junction line extending from the first transverse plane to the second transverse plane, and in which a difference between the second radius and the first radius has a zero value from the first transverse plane to a third transverse plane located between the first transverse plane and the second transverse plane, then which increases continuously from a zero value in the third transverse plane, to a maximum value in a fourth transverse plane located between the third transverse plane and the second transverse plane, and which decreases continuously from the maximum value in the fourth transverse plane to a zero value in the second transverse plane;
the third transverse plane is defined as a transverse plane passing through a point on the fourth junction line where the curvature of the fourth junction line is maximum;
the first junction line has a first radius with a constant value from the first transverse plane to the second transverse plane;
the first junction line has a first radius with a constant value from the first transverse plane to the third transverse plane, then decreasing continuously from the third transverse plane to the fourth transverse plane, and increasing continuously from the fourth transverse plane to the second transverse plane;
the second junction line has a second radius with a constant value from the first transverse plane to the third transverse plane, then increasing continuously from the third transverse plane to the fourth transverse plane, and decreasing continuously from the fourth transverse plane to the second transverse plane;
an axial distance between the third transverse plane and the second transverse plane is comprised between 10% and 40% of a chord length of the profiled part, the chord length of the profiled part being defined as a distance between a point of intersection between the leading edge and the guide surface of the platform and a point of intersection between the trailing edge and the guide surface of the platform.

The invention further concerns a gas turbine engine stator assembly, comprising:
a shroud having a central axis,
a set of guide vanes comprising a plurality of guide vanes, each guide vane comprising a platform with a guide surface and a profiled part extending radially from the guide surface of the platform, the profiled part having an intrados surface and an extrados surface, and the platform having a first lateral surface and a second lateral surface, and the guide surface of the platform comprising a first guide surface part extending from the intrados surface of the profiled part to the first lateral surface and a second guide surface part extending from the extrados surface of the profiled part to the second lateral surface,
the guide vanes being fixed to the shroud such that the second lateral surface of each guide vane is disposed facing a first lateral surface of an adjacent guide vane of the set of guide vanes, and the first guide surface parts and the second guide surface parts of the platforms delimit a flow path for a gas stream flowing between the profiled parts of the guide vanes,
wherein each guide vane has a first junction line formed at the intersection between the first guide surface part and the first lateral surface, a second junction line formed at the intersection between the second guide surface part and the second lateral surface, a third junction line formed at the intersection between the first guide surface part and the intrados surface, and a fourth junction line formed at the intersection between the second guide surface part and the extrados surface,
and wherein the first junction line has a first radius measured from the central axis in a plane transverse to the central axis, the second junction line has a second radius measured from the central axis, in the plane transverse to the central axis, the second radius being greater than the first radius, such that a portion of the second lateral surface extends into the gas stream by forming a wall preventing parasitic circulation of part of the gas stream from the intrados surface of a guide vane to the extrados surface of an adjacent guide vane, the third junction line has a third radius measured from the central axis in the plane transverse to the central axis, and the fourth junction line has a fourth radius measured from the central axis in the plane transverse to the central axis, the fourth radius being less than or equal to the third radius.

In such an assembly, each guide vane may have one of the characteristics defined above.

The guide vanes of the set of guide vanes may be identical to each other.

In one possible embodiment, the shroud is an inner straightener shroud and the guide surfaces of the platforms of the guide vanes form an inner wall of the gas stream flow duct.

In another possible embodiment, the shroud is an outer straightener shroud and the guide surfaces of the platforms of the guide vanes form an outer wall of the gas stream flow duct.

The assembly may be a compressor stator straightener assembly or a turbine stator straightener assembly or a fan straightener assembly.

The invention further concerns a gas turbine engine comprising an assembly as defined above.

### PRESENTATION OF THE DRAWINGS

Other characteristics and advantages will emerge from the following description, which is purely illustrative and non-limiting, and should be read in relation to the appended figures, among which:

FIG. 1 schematically represents, in longitudinal section, a gas turbine engine,

FIG. 2 schematically represents a stator straightener assembly of a gas turbine engine,

FIG. 3 schematically represents guide vanes assembled on a stator shroud,

FIG. 4 schematically represents an assembly of two guide vanes in accordance with a first embodiment of the invention,

FIG. 5 schematically represents an assembly of two guide vanes in accordance with a second embodiment of the invention,

FIG. 6 schematically represents a top view of an assembly of two guide vanes,

FIGS. 7A to 7C schematically represent the two guide vanes in accordance with the first embodiment, in three different transverse cutting planes,

FIG. 7D schematically represents a view of the side of the extrados of one of the guide vanes of the assembly,

FIG. 7E schematically represents a view of the side of the intrados of the other of the guide vanes of the assembly,

FIGS. 8A to 8C schematically represent the two guide vanes in accordance with the second embodiment, in three different transverse cutting planes,

FIG. 8D schematically represents a view of the side of the extrados of one of the guide vanes of the assembly,

FIG. 8E schematically represents a view of the side of the intrados of the other of the guide vanes of the assembly.

### DETAILED DESCRIPTION OF ONE EMBODIMENT

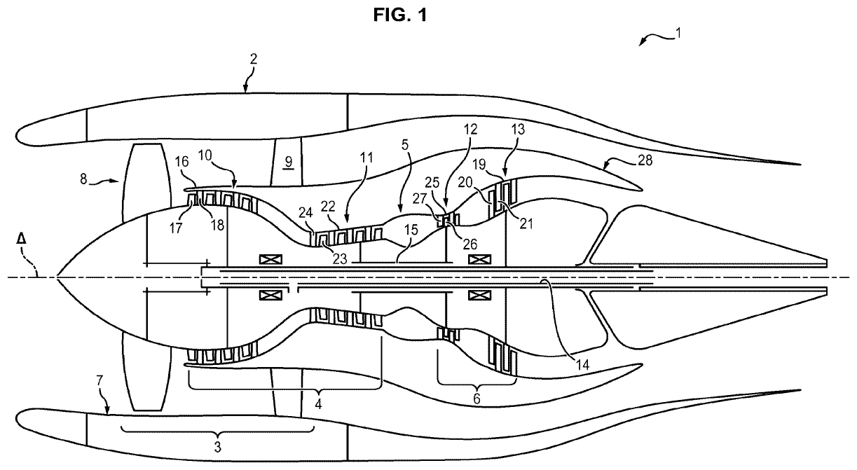

In FIG. 1, the gas turbine engine 1 represented is a twin-spool turbofan gas turbine engine.

The gas turbine engine 1 has a longitudinal axis Δ.

The gas turbine engine 1 comprises a nacelle 2, a fan section 3, a compressor section 4, a combustion chamber 5, and a turbine section 6.

In the example illustrated in FIG. 1, the fan section 3 comprises a fan casing 7 fixedly mounted relative to the nacelle, a fan 8 capable of being driven in rotation relative to the fan casing 7, and outlet guide vanes 9 (OGV) fixedly mounted on the fan casing 7 and having the function of straightening the secondary air stream which flows at the outlet of the fan 8.

In the example illustrated in FIG. 1, the compressor section 4 comprises a low-pressure compressor 10 and a high-pressure compressor 11.

In addition, the turbine section 6 comprises a high-pressure turbine 12 and a low-pressure turbine 13.

The gas turbine engine 1 comprises a low-pressure shaft 14 connecting the low-pressure turbine 13 to the low-pressure compressor 10 and to the fan 8, and a high-pressure shaft 15 connecting the high-pressure turbine 12 to the high-pressure compressor 11. The high-pressure shaft 15 is coaxial with the low-pressure shaft 14 and extends around the low-pressure shaft 14. The high-pressure shaft 15 and the low-pressure shaft 14 are rotatably mounted relative to the nacelle 2, about the longitudinal axis Δ of the engine.

The fan 8, the low-pressure compressor 10, the low-pressure turbine 13, and the low-pressure shaft 14 together form the low-pressure body of the engine 1. The low-pressure turbine 13 is capable of driving in rotation the low-pressure compressor 10 and the fan 8 via the low-pressure shaft 14.

More specifically, the low-pressure compressor 10 comprises a low-pressure compressor casing 16, fixedly mounted relative to the nacelle 2, a low-pressure compressor rotor 17, and a low-pressure compressor stator 18. The low-pressure compressor rotor 17 is capable of being driven in rotation relative to the low-pressure compressor stator 18, about the longitudinal axis Δ of the engine 1. The low-pressure compressor rotor 17 comprises blades. The low-pressure compressor stator 18 comprises vanes (also called “guide vanes” or “straightener vanes”) which are fixedly mounted on the casing of the low-pressure compressor 16 by being interposed between the blades. These vanes have the function of guiding the primary air stream through the low-pressure compressor 10.

Similarly, the low-pressure turbine 13 comprises a low-pressure turbine casing 19, fixedly mounted relative to the nacelle 2, a low-pressure turbine rotor 20, and a low-pressure turbine stator 21. The low-pressure turbine rotor 20 is capable of being driven in rotation relative to the low-pressure turbine stator 21, about the longitudinal axis Δ of the engine 1. The low-pressure turbine rotor 20 comprises blades. The low-pressure turbine stator 21 comprises vanes which are fixedly mounted on the casing of the low-pressure turbine 19 by being interposed between the blades. These vanes have the function of guiding the primary air stream through the low-pressure turbine 13.

The low-pressure turbine rotor 20 is connected to the low-pressure compressor rotor 17 via the low-pressure shaft 14. Thus, when the engine 1 is operating, the rotation of the low-pressure turbine rotor 20 causes a rotation of the low-pressure compressor rotor 17.

The high-pressure compressor 11, the high-pressure turbine 12, and the high-pressure shaft 15 together form the high-pressure body of the engine 1. The high-pressure turbine 12 is capable of driving in rotation the high-pressure compressor 11 via the high-pressure shaft 15.

More specifically, the high-pressure compressor 11 comprises a high-pressure compressor casing 22, fixedly mounted relative to the nacelle 2, a high-pressure compressor rotor 23, and a high-pressure compressor stator 24. The high-pressure compressor rotor 23 is capable of being driven in rotation relative to the high-pressure compressor stator 24, about the longitudinal axis Δ of the engine 1. The high-pressure compressor rotor 23 comprises blades. The high-pressure compressor stator 24 comprises vanes (also called “guide vanes” or “straightener vanes”) which are fixedly mounted on the casing 22 of the high-pressure compressor by being interposed between the blades. These vanes have the function of guiding the primary air stream through the high-pressure compressor 11.

Likewise, the high-pressure turbine 12 comprises a high-pressure turbine casing 25 fixedly mounted relative to the nacelle 2, a high-pressure turbine rotor 26, and a high-pressure turbine stator 27. The high-pressure turbine rotor 26 is capable of being driven in rotation relative to the high-pressure turbine stator 27, about the longitudinal axis Δ of the engine 1. The high-pressure turbine rotor 26 comprises blades. The high-pressure turbine stator 27 comprises vanes which are fixedly mounted on the casing 25 of the high-pressure turbine by being interposed between the blades. These vanes have the function of guiding the primary air stream through the high-pressure turbine 12.

The high-pressure turbine rotor 26 is connected to the high-pressure compressor rotor 23 via the high-pressure shaft 15. Thus, when the engine 1 is operating, the rotation of the high-pressure turbine rotor 26 causes a rotation of the high-pressure compressor rotor 23.

The outlet guide vanes 9 of the fan section 3, the vanes of the stator 18 of the low-pressure compressor 10, the vanes of the high-pressure compressor stator 24, the vanes of the high-pressure turbine stator 27 and the vanes of the low-pressure turbine stator 21 are examples of guide vanes.

When the engine 1 is operating, the fan 8 and the low-pressure compressor 10 are driven in rotation by the low-pressure turbine 13. Similarly, the high-pressure compressor 11 is driven in rotation by the high-pressure turbine 12.

Air is drawn in by the fan 8. The air drawn in by the fan 8 is divided between a primary air stream and a secondary air stream, which circulate from upstream to downstream of the gas turbine engine 1.

The primary air stream flows from upstream to downstream of the gas turbine engine 1 in a primary duct, by passing successively through the low-pressure compressor 10, the high-pressure compressor 11, the combustion chamber 5 where it is mixed with fuel to serve as an oxidant, the high-pressure turbine 12 and the low-pressure turbine 13. The passage of the primary air stream through the high-pressure turbine 12 and the low-pressure turbine 13 causes a rotation of the rotors 26 and 29 of the turbines which in turn drive in rotation the rotors 23 and 17 of the high-pressure and low-pressure compressors, as well as the fan 8 via the high-pressure shaft 15 and the low-pressure shaft 14. The primary air stream escapes from the engine 1 through an exhaust casing 28, located downstream of the low-pressure turbine casing 19.

The secondary air stream (also called “bypass air stream”) flows from upstream to downstream of the gas turbine engine 1 in a secondary duct. This secondary air stream does not pass into the combustion chamber 5 and does not drive the turbines 12 and 13. The secondary air stream serves to cool the periphery of the engine body and to generate most part of the thrust provided by the gas turbine engine. The secondary air stream flows through the vanes 9 mounted on the fan casing 7, downstream of the fan 8.

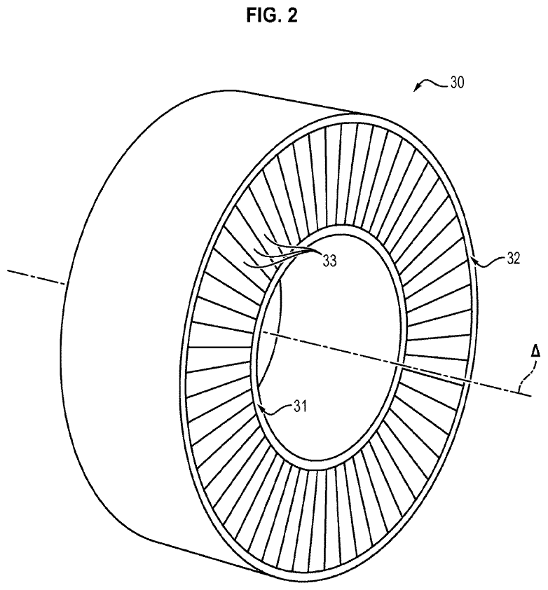

FIG. 2 schematically illustrates a stator straightener assembly 30 of a gas turbine engine 1. In the example illustrated in FIG. 2, the assembly 30 is a fan straightener assembly. However, it could be a compressor stator straightener assembly or a turbine stator straightener assembly.

The assembly 30 comprises an inner shroud 31, an outer shroud 32, extending around the inner shroud 31, and a series of guide vanes 33.

The inner shroud 31 has an annular shape with a central axis. Similarly, the outer shroud 32 has an annular shape, with a central axis coincident with the central axis of the inner shroud. In addition, when the assembly 30 is mounted in the engine, the central axes coincide with the central axis Δ of the engine.

Each guide vane 33 extends radially from the inner shroud 31 to the outer shroud 32. The guide vanes 33 form a cascade for guiding the air stream flowing between the guide vanes 33.

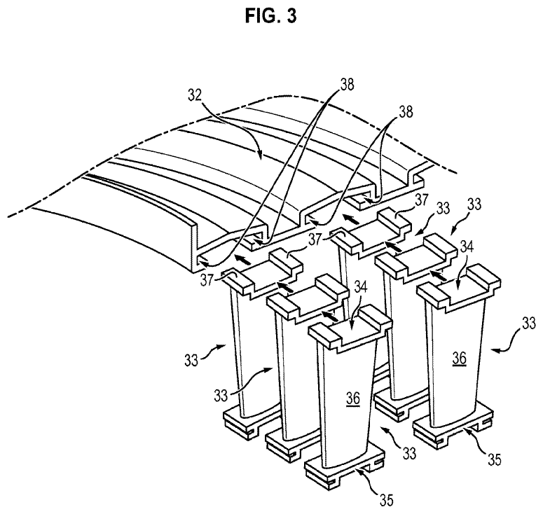

FIG. 3 shows how the guide vanes 33 can be mounted on a shroud 32.

In the example illustrated in FIG. 3, the guide vanes 33 are identical to each other. Each guide vane 33 comprises a first platform 34, a second platform 35 and a profiled part 36, extending radially from the first platform 34 to the second platform 35. The first platform 34 is intended to be positioned radially outwardly relative to the second platform 35, relative to the axis Δ of the engine.

In the example illustrated in FIG. 3, the guide vanes 33 are mounted on the outer shroud 32. However, the guide vanes 33 can also be mounted in the same way on the inner shroud 31.

For this purpose, the first platform 34 of each guide vane 33 comprises protrusions 37 capable of being engaged in circumferential grooves 38 of the shroud 32, in order to fix each guide vane 33 on the shroud 32.

The guide vanes 33 are thus disposed next to each other over the entire circumference of the shroud 32, so as to form a row of guide vanes. The guide vanes 33 of the same row can have a constant angular spacing between two consecutive guide vanes.

Each first platform 34 has a guide surface from which the profiled part 36 extends. Similarly, each second platform 35 has a guide surface from which the profiled part 36 extends.

Once the guide vanes 33 are mounted, the guide surfaces of the first platforms 34 of the guide vanes 33 form an outer wall of the gas stream flow duct. The guide surfaces of the second platforms 35 of the guide vanes form an inner wall of the gas stream flow duct.

In the example illustrated in FIG. 3, the assembly 30 comprises two rows of guide vanes 33 mounted on the shroud 32. However, it would be possible to mount a single row of guide vanes or more than two rows of guide vanes on the same shroud.

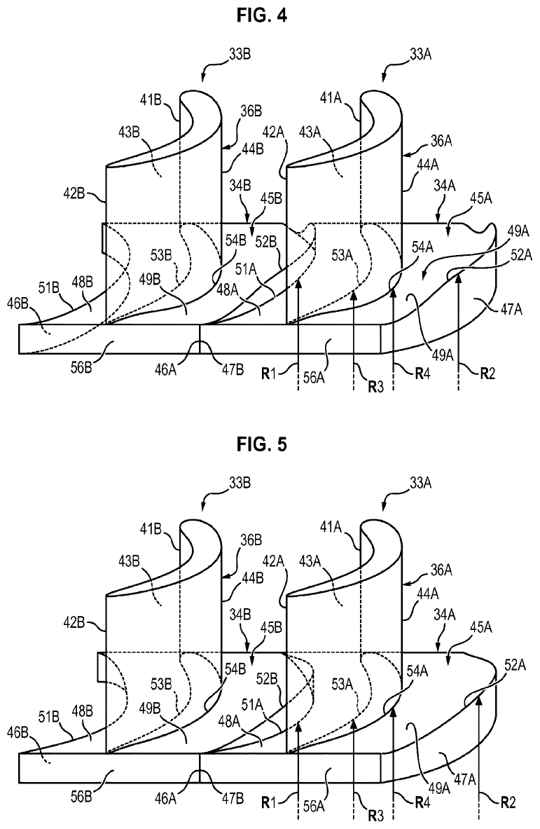

FIG. 4 schematically represents two adjacent guide vanes 33A and 33B of the same row, in accordance with a first embodiment of the invention.

The two guide vanes 33A and 33B are identical to each other.

Each guide vane 33A, 33B comprises a platform 34A, 34B and a profiled part 36A, 36B.

The profiled part 36A, 36B has a leading edge 41A, 41B, a trailing edge 42A, 42B, an intrados surface 43A, 43B and an extrados surface 44A, 44B.

The platform 34A, 34B has a guide surface 45A, 45B from which the profiled part 36A, 36B, a first lateral surface 46A, 46B and a second lateral surface 47A, 47B extend.

As illustrated in FIG. 4, the second lateral surface 47B is capable of being disposed facing the first lateral surface 46A of the adjacent guide vane. More specifically, in the example illustrated in FIG. 4, the second lateral surface 47B is capable of being disposed against the first lateral surface 46A, so that the platforms 34A and 34B of the two adjacent vanes 33A and 33B fit together.

In this way, the platform 34B of the guide vane 33B delimits with the platform 34A of the adjacent guide vane 33A a flow path for the gas stream flowing between the profiled part 36B of the guide vane 33B and the profiled part 36A of the adjacent guide vane 33A.

The guide surface 45A, 45B of each guide vane 33A, 33B comprises a first guide surface part 48A, 48B and a second guide surface part 49A, 49B. The first guide surface part 48A, 48B extends from the intrados surface 43A, 43B of the profiled part 36A, 36B to the first lateral surface 46A, 46B. The second guide surface part 49A, 49B extends from the extrados surface 44A, 44B of the profiled part 36A, 36B to the second lateral surface 47A, 47B.

A first junction line 51A, 51B is formed at the intersection between the first guide surface part 48A, 48B and the first lateral surface 46A, 46B. When the guide vane 33A, 33B is fixed to the shroud 32, the first junction line 51A, 51B has a first radius R1 measured from the central axis Δ of the shroud 32 in a plane transverse to the central axis Δ.

Similarly, a second junction line 52A, 52B is formed at the intersection between the second guide surface part 49A, 49B and the second lateral surface 47A, 47B. The second junction line 52A, 52B has a second radius R2 measured from the central axis Δ of the shroud 32, in the plane transverse to the central axis Δ.

As can be seen in FIG. 4, the second radius R2 is greater than the first radius R1, so as to form a step (or a recess) between the second guide surface 49B of the guide vane 33B and the first guide surface 48A of the adjacent guide vane 33A.

Thus, a portion of the second lateral surface 47B is not covered by the first lateral surface 46A and extends into the gas stream by forming a wall preventing parasitic circulation of part of the gas stream from the intrados surface 43A of the guide vane 33A to the extrados surface 44B of the guide vane 33B.

Moreover, a third junction line 53A, 53B is formed at the intersection between the first guide surface part 48A, 48B and the intrados surface 43A, 43B. The third junction line 53A, 53B has a third radius 53 measured from the central axis Δ of the shroud 32, in the plane transverse to the central axis Δ.

Similarly, a fourth junction line 54A, 54B is formed at the intersection between the second guide surface part 49A, 49B and the extrados surface 44A, 44B. The fourth junction line 54A, 54B has a fourth radius R4 measured from the central axis Δ of the shroud 32, in the plane transverse to the central axis Δ.

As can be seen in FIG. 4, in this first embodiment, the fourth radius R4 is smaller than the third radius R3.

In other words, the second guide surface part 49A, 49B forms a depression in the vicinity of the extrados surface 44A, 44B of the profiled part 33A, 33B, while it forms an extra height in the vicinity of the second lateral surface 47A, 47B. This depression makes it possible to compensate for the obstruction generated by the extra height which has the effect of reducing the gas stream passage section between the two profiled parts 36A and 36B.

FIG. 5 schematically represents two adjacent guide vanes 33A, 33B of the same row, in accordance with a second embodiment of the invention.

This second embodiment is identical to the first embodiment, except that in this second embodiment, the first guide surface part 48A, 48B and the second guide surface part 49A, 49B are configured such that the fourth radius R4 is equal to the third radius R3.

On the other hand, the first radius R1 is smaller than the third radius R3.

In other words, in this second embodiment, it is the first guide surface part 48A, 48B that has a depression in the vicinity of the first lateral surface 46A, 46B. This depression in the first guide surface part 48A, 48B makes it possible to compensate for the obstruction generated by the extra height of the second guide surface part 49A, 49B in the vicinity of the second lateral surface 47A, 47B, which has the effect of reducing the passage section of the gas stream between the two profiled parts 36A and 36B.

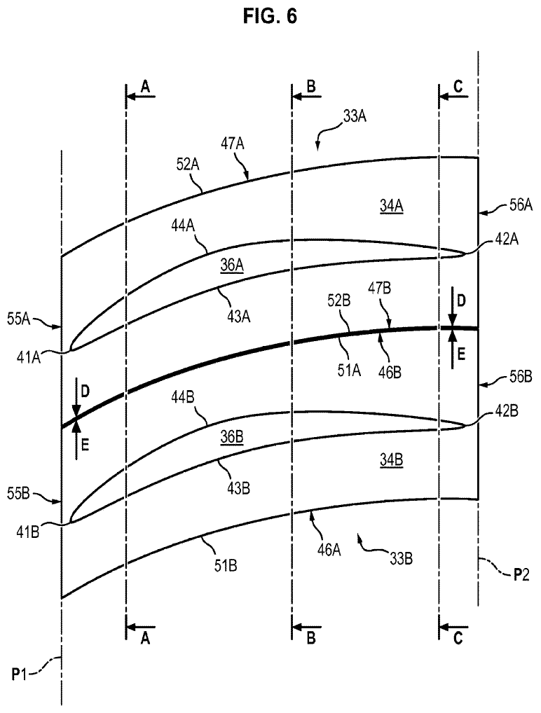

FIG. 6 schematically represents, in a top view, an assembly of two guide vanes 33A and 33B. This view is identical for the two preceding embodiments.

As can be seen in FIG. 6, the first lateral surface 46A, 46B and the second lateral surface 47A, 47B are not planar.

More specifically, the first lateral surface 46A, 46B of each platform 34A, 34B has a concave shape and the second lateral surface 47A, 47B of each platform 34A, 34B has a convex shape, intended to fit with the concave shape of the first lateral surface 46A, 46B of the platform of the adjacent guide vane.

Moreover, each platform 34A, 34B has a first transverse surface 55A, 55B extending in a first transverse plane P1 located upstream of the leading edge 41A, 41B, and a second transverse surface 56A, 56B extending in a second transverse plane P2 located downstream of the trailing edge 42A, 42B.

The first junction line 51A, 51B extends from the first transverse plane P1 to the second transverse plane P2.

Likewise, the second junction line 52A, 52B extends from the first transverse plane P1 to the second transverse plane P2.

The first radius R1 and the second radius R2 vary continuously from the first transverse plane P1 to the second transverse plane P2.

The third radius R3 and the fourth radius R4 vary continuously from the leading edge 41A, 41B to the trailing edge 42A, 42B of the profiled part 36A, 36B.

FIG. 6 illustrates three distinct cutting planes A-A, B-B and C-C, extending transversely relative to the central axis Δ of the shroud 32 by cutting the profiled part 36A, 36B.

The cutting plane A-A is located upstream of the cutting plane B-B, which is itself located upstream of the cutting plane C-C, in the direction of flow of the gas stream.

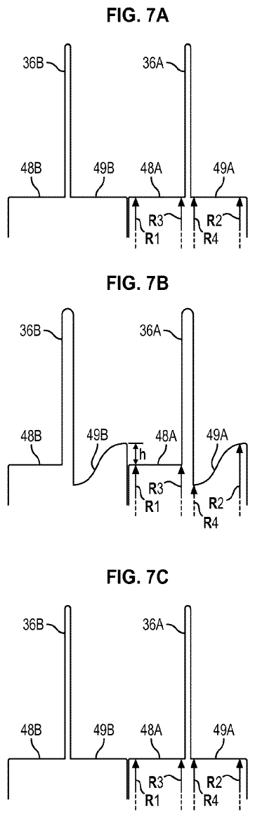

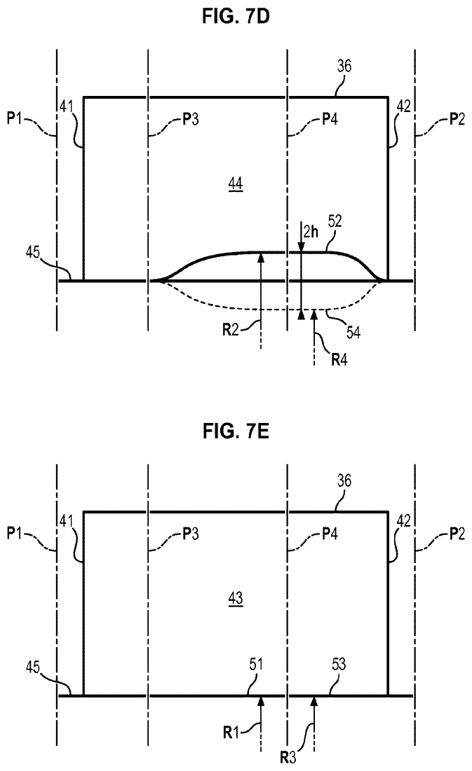

FIGS. 7A to 7C schematically represent the two guide vanes 33A, 33B respectively in the three different transverse cutting planes A-A, B-B and C-C, in accordance with the first embodiment.

As can be seen in FIG. 7A, in the cutting plane A-A, the first radius R1, the second radius R2, the third radius R3 and the fourth radius R4 are equal.

As can be seen in FIG. 7B, in the cutting plane B-B, the second radius R2 is greater than the first radius R1. In addition, the fourth radius R4 is smaller than the third radius R3.

In addition, a difference between the second radius R2 and the first radius R1 is equal to a difference between the third radius R3 and the fourth radius R4.

In other words: R2−R1=R3−R4 and max (R2−R1)=max(R3−R4)=h

As can be seen in FIG. 7C, in the cutting plane C-C, the first radius R1, the second radius R2, the third radius R3 and the fourth radius R4 are again equal.

FIG. 7D shows a variation of the second radius R2 (in solid line) relative to the first radius R1 between the first transverse plane P1 and the second transverse plane P2, and a variation of the fourth radius R4 (in dotted lines) relative to the third radius R3 between the leading edge 41 and the trailing edge 42.

The first radius R1 has a constant value from the first transverse plane P1 to the second transverse plane P2.

In contrast, as can be seen in FIG. 7D, the value of the second radius R2 varies continuously from the first transverse plane P1 to the second transverse plane P2 such that a difference between the second radius R2 and the first radius R1 has a zero value from the first transverse plane P1 to a third transverse plane P3 located between the first transverse plane P1 and the second transverse plane P2, then this difference increases continuously from a zero value in the third transverse plane P3, to a maximum value h in a fourth transverse plane P4 located between the third transverse plane P3 and the second transverse plane P2, and then this difference decreases continuously from the maximum value in the fourth transverse plane P4 to a zero value in the second transverse plane P2.

The third transverse plane P3 is defined as a transverse plane passing through a point of the fourth junction line 54 where the curvature of the fourth junction line 54 (and consequently of the extrados surface 44) is maximum.

In this way, the third transverse plane P3 is located in an area in which shocks are likely to occur due to a flow of the gas stream at high speeds.

An axial distance between the third transverse plane P3 and the second transverse plane P2 is comprised between 10% and 40% of a chord length of the profiled part 36, the chord length of the profiled part 36 being defined as a distance between a point of intersection between the leading edge 41 and the guide surface 45 of the platform 34 and a point of intersection between the trailing edge 42 and the guide surface 45 of the platform 34.

The third radius R3 has a constant value from the leading edge 41 to the trailing edge 42.

On the other hand, as can be seen in FIG. 7D, the fourth radius R4 has a value that varies continuously from the leading edge 41 to the trailing edge 42, such that the difference between the second radius R2 and the first radius R1 is always equal to the difference between the third radius R3 and the fourth radius R4, in any transverse plane.

Thus, the difference between the third radius R3 and the fourth radius R4 has a maximum value h in the fourth transverse plane P4.

Consequently, in this fourth transverse plane P4, the difference between the second radius R2 and the fourth radius R4 is 2h.

FIG. 7E shows that the first radius R1 is constant from the first transverse plane P1 to the second transverse plane P2 and that the third radius R3 is equal to the first radius R1 from the leading edge 41 to the trailing edge 42 of the profiled part 36.

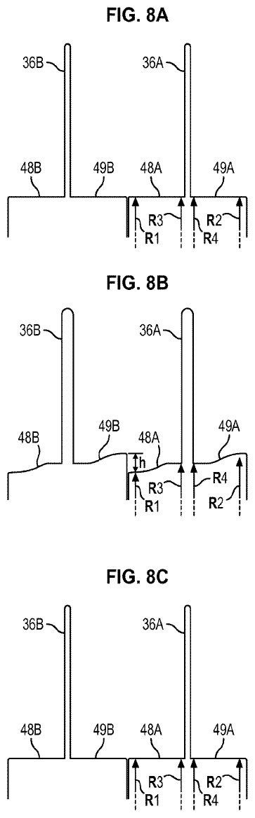

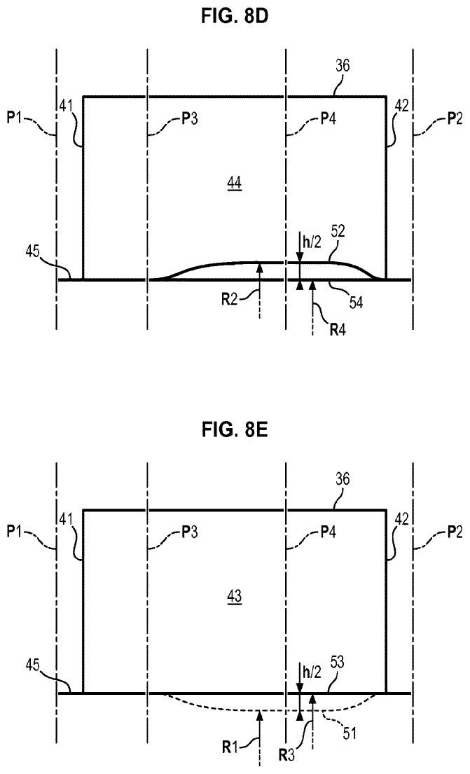

FIGS. 8A to 8C schematically represent the two guide vanes 33A and 33B in the three different transverse cutting planes A-A, B-B and C-C, in accordance with the second embodiment.

As can be seen in FIG. 8A, in the cutting plane A-A, the first radius R1, the second radius R2, the third radius R3, and the fourth radius R4 are equal.

As can be seen in FIG. 8B, in the cutting plane B-B, the second radius R2 is greater than the first radius R1. On the other hand, the third radius R3 and the fourth radius R4 are equal.

In addition, a difference between the third radius R3 and the first radius R1 is equal to a difference between the second radius R2 and the fourth radius R4.

In other words: R3−R1=R2−R4 and max(R3−R1)=max(R2−R4)=h/2

As can be seen in FIG. 8C, in the cutting plane C-C, the first radius R1, the second radius R2, the third radius R3, and the fourth radius R4 are again equal.

FIG. 8D shows a variation of the second radius R2 relative to the fourth radius R4, while FIG. 8E shows a variation of the first radius R1 relative to the third radius R3 between the first transverse plane P1 and the second transverse plane P2.

The fourth radius R4 has a constant value from the leading edge 41 to the trailing edge 42 of the profiled part 36.

On the other hand, as can be seen in FIG. 8D, the value of the second radius R2 varies continuously from the first transverse plane P1 to the second transverse plane P2 such that a difference between the second radius R2 and the fourth radius R4 has a zero value from the leading edge 41 to a third transverse plane P3 located between the first transverse plane P1 and the second transverse plane P2, then this difference increases continuously from a zero value in the third transverse plane P3, to a maximum value h/2 in a fourth transverse plane P4 located between the third transverse plane P3 and the second transverse plane P2, and then this difference decreases continuously from the maximum value h/2 in the fourth transverse plane P4 to a zero value in the second transverse plane P2.

The third transverse plane P3 is defined as a transverse plane passing through a point of the fourth junction line 54 where the curvature of the fourth junction line 54 (and consequently of the extrados surface 44) is maximum.

In this way, the third transverse plane P3 is located in an area in which shocks are likely to occur due to a flow of the gas stream at high speeds.

Symmetrically, the third radius R3 has a constant value from the leading edge 41 to the trailing edge 42 of the profiled part 36, equal to the value of the fourth radius R4.

On the other hand, as can be seen in FIG. 8E, the second radius R2 has a value that varies continuously from the leading edge 41 to the trailing edge 42, such that the difference between the third radius R3 and the second radius R2 is always equal to the difference between the second radius R2 and the fourth radius R4, in any transverse plane.

Thus, the difference between the second radius R2 and the fourth radius R4 has a maximum value h/2 in the fourth transverse plane P4.

Likewise, the difference between the third radius R3 and the first radius R1 also has a maximum value h/2 in the fourth transverse plane P4.

Consequently, in this fourth transverse plane P4, the difference between the second radius R2 and the first radius R1 is h.

1. A guide vane intended to be fixed on a stator shroud of a gas turbine engine comprising:
a profiled part intended to extend into a gas stream to guide the gas stream, the profiled part having an intrados surface and an extrados surface, and
a platform having a guide surface from which the profiled part extends, a first lateral surface and a second lateral surface the second lateral surface being capable of being disposed facing a first lateral surface of an identical adjacent guide vane, such that the platform of the guide vane delimits with the platform of the adjacent guide vane a flow path for the gas stream flowing between the profiled part of the guide vane and the profiled part of the adjacent guide vane,
the guide surface comprising a first guide surface part extending from the intrados surface of the profiled part to the first lateral surface and a second guide surface part extending from the extrados surface of the profiled part to the second lateral surface,
wherein a first junction line is formed at the intersection between the first guide surface part and the first lateral surface, a second junction line is formed at the intersection between the second guide surface part and the second lateral surface, a third junction line is formed at the intersection between the first guide surface part and the intrados surface, and a fourth junction line is formed at the intersection between the second guide surface part and the extrados surface,
the first guide surface part and the second guide surface part being configured such that when the guide vane is fixed to the shroud, the first junction line has a first radius measured from the central axis of the shroud in a plane transverse to the central axis, the second junction line has a second radius measured from the central axis, in the plane transverse to the central axis, the second radius being greater than the first radius, the third junction line has a third radius measured from the central axis, in the plane transverse to the central axis, and the fourth junction line has a fourth radius measured from the central axis in the plane transverse to the central axis, the fourth radius being less than the third radius.

2. The guide vane according to claim 1, wherein the first radius is equal to the third radius.

3. The guide vane according to claim 2, wherein a difference between the second radius and the first radius is equal to a difference between the third radius and the fourth radius.

4. (canceled)

5. (canceled)

6. The guide vane according to claim 1, wherein the profiled part has a leading edge and a trailing edge and the platform has a first transverse surface extending in a first transverse plane located upstream of the leading edge, and a second transverse surface extending in a second transverse plane located downstream of the trailing edge the first junction line extending from the first transverse plane to the second transverse plane and the second junction line extending from the first transverse plane to the second transverse plane, and wherein a difference between the second radius and the first radius has a zero value from the first transverse plane to a third transverse plane located between the first transverse plane and the second transverse plane, then which increases continuously from a zero value in the third transverse plane, to a maximum value in a fourth transverse plane located between the third transverse plane and the second transverse plane, and which decreases continuously from the maximum value in the fourth transverse plane to a zero value in the second transverse plane.

7. The guide vane according to claim 6, wherein the third transverse plane is defined as a transverse plane passing through a point on the fourth junction line where the curvature of the fourth junction line is maximum.

8. The guide vane according to claim 6, wherein the first junction line has a first radius with a constant value from the first transverse plane to the second transverse plane.

9. The guide vane according to claim 6, wherein the first junction line has a first radius with a constant value from the first transverse plane to the third transverse plane, then decreasing continuously from the third transverse plane to the fourth transverse plane and increasing continuously from the fourth transverse plane to the second transverse plane.

10. The guide vane according to claim 6, wherein the second junction line has a second radius with a constant value from the first transverse plane to the third transverse plane then increasing continuously from the third transverse plane to the fourth transverse plane, and decreasing continuously from the fourth transverse plane to the second transverse plane.

11. The guide vane according to claim 6, wherein an axial distance between the third transverse plane and the second transverse plane is comprised between 10% and 40% of a chord length of the profiled part, the chord length of the profiled part being defined as a distance between a point of intersection between the leading edge and the guide surface of the platform and a point of intersection between the trailing edge and the guide surface of the platform

12. A gas turbine engine stator assembly, comprising:
a shroud having a central axis,
a set of guide vanes comprising a plurality of guide vanes, each guide vane comprising a platform with a guide surface(45) and a profiled part extending radially from the guide surface of the platform, the profiled part having an intrados surface and an extrados surface, and the platform having a first lateral surface and a second lateral surface, and the guide surface of the platform comprising a first guide surface part extending from the intrados surface of the profiled part to the first lateral surface and a second guide surface part extending from the extrados surface from the profiled part to the second lateral surface, the guide vanes being fixed to the shroud such that the second lateral surface of each guide vane is disposed facing a first lateral surface of an adjacent guide vane of the set of guide vanes, and the first guide surface parts and the second guide surface parts of the platforms delimit a flow path for a gas stream flowing between the profiled parts of the guide vanes,
wherein each guide vane has a first junction line formed at the intersection between the first guide surface part and the first lateral surface, a second junction line formed at the intersection between the second guide surface part and the second lateral surface a third junction line formed at the intersection between the first guide surface part and the intrados surface, and a fourth junction line formed at the intersection between the second guide surface part and the extrados surface,
and wherein the first junction line has a first radius measured from the central axis, in a plane transverse to the central axis, the second junction line has a second radius measured from the central axis, in the plane transverse to the central axis, the second radius being greater than the first radius, such that a portion of the second lateral surface extends into the gas stream by forming a wall preventing parasitic circulation of part of the gas stream from the intrados surface of a guide vane to the extrados surface of an adjacent guide vane the third junction line has a third radius measured from the central axis, in the plane transverse to the central axis, and the fourth junction line has a fourth radius measured from the central axis, in the plane transverse to the central axis, the fourth radius being less than the third radius.

13. (canceled)

14. The assembly according to claim 12. wherein the guide vanes of the set of guide vanes are identical to each other.

15. The assembly according to claim 12, wherein the shroud is an inner straightener shroud and the guide surfaces of the platforms of the guide vanes form an inner wall of the gas stream flow duct.

16. The assembly according to claim 12, wherein the shroud is an outer straightener shroud and the guide surfaces of the platforms of the guide vanes form an outer wall of a gas stream flow duct.

17. The assembly according to claim 12, wherein the assembly is a compressor stator straightener assembly or a turbine stator straightener assembly or a fan straightener assembly.

18. A gas turbine engine comprising an assembly according to claim 12.

19. The gas turbine engine stator assembly according to claim 12, wherein the first radius is equal to the third radius.

20. The gas turbine engine stator assembly according to claim 13, wherein a difference between the second radius and the first radius is equal to a difference between the third radius and the fourth radius.

21. A guide vane intended to be fixed on a stator shroud of a gas turbine engine, comprising:
a profiled part intended to extend into a gas stream to guide the gas stream, the profiled part having an intrados surface and an extrados surface, and
a platform having a guide surface from which the profiled part extends, a first lateral surface and a second lateral surface, the second lateral surface being capable of being disposed facing a first lateral surface of an identical adjacent guide vane, such that the platform of the guide vane delimits with the platform of the adjacent guide vane a flow path for the gas stream flowing between the profiled part of the guide vane and the profiled part of the adjacent guide vane, the guide surface comprising a first guide surface part extending from the intrados surface of the profiled part to the first lateral surface and a second guide surface part extending from the extrados surface of the profiled part to the second lateral surface,
wherein a first junction line is formed at the intersection between the first guide surface part and the first lateral surface, a second junction line is formed at the intersection between the second guide surface part and the second lateral surface, a third junction line is formed at the intersection between the first guide surface part and the intrados surface, and a fourth junction line is formed at the intersection between the second guide surface part and the extrados surface, the first guide surface part and the second guide surface part being configured such that when the guide vane is fixed to the shroud, the first junction line has a first radius measured from the central axis of the shroud in a plane transverse to the central axis, the second junction line has a second radius measured from the central axis, in the plane transverse to the central axis, the second radius being greater than the first radius, the third junction line has a third radius measured from the central axis, in the plane transverse to the central axis, and the fourth junction line has a fourth radius measured from the central axis in the plane transverse to the central axis, the fourth radius being equal to the third radius and a difference between the second radius and the fourth radius being equal to a difference between the third radius and the first radius.

22. The guide vane according to claim 21, wherein the profiled part has a leading edge and a trailing edge, and the platform has a first transverse surface extending in a first transverse plane located upstream of the leading edge, and a second transverse surface extending in a second transverse plane located downstream of the trailing edge, the first junction line extending from the first transverse plane to the second transverse plane and the second junction line extending from the first transverse plane to the second transverse plane, and wherein a difference between the second radius and the first radius has a zero value from the first transverse plane to a third transverse plane located between the first transverse plane and the second transverse plane, then which increases continuously from a zero value in the third transverse plane, to a maximum value in a fourth transverse plane located between the third transverse plane and the second transverse plane, and which decreases continuously from the maximum value in the fourth transverse plane to a zero value in the second transverse plane.

23. The guide vane according to claim 22, wherein the third transverse plane is defined as a transverse plane passing through a point on the fourth junction line where the curvature of the fourth junction line is maximum.

24. The guide vane according to claim 22, wherein the first junction line has a first radius with a constant value from the first transverse plane to the second transverse plane.

25. The guide vane according to claim 22, wherein the first junction line has a first radius with a constant value from the first transverse plane to the third transverse plane, then decreasing continuously from the third transverse plane to the fourth transverse plane, and increasing continuously from the fourth transverse plane to the second transverse plane.

26. The guide vane according to claim 22, wherein the second junction line has a second radius with a constant value from the first transverse plane to the third transverse plane, then increasing continuously from the third transverse plane to the fourth transverse plane, and decreasing continuously from the fourth transverse plane to the second transverse plane.

27. The guide vane according to claim 23, wherein an axial distance between the third transverse plane and the second transverse plane is comprised between 10% and 40% of a chord length of the profiled part, the chord length of the profiled part being defined as a distance between a point of intersection between the leading edge and the guide surface of the platform and a point of intersection between the trailing edge and the guide surface of the platform.

28. A gas turbine engine stator assembly, comprising:
a shroud having a central axis,
a set of guide vanes comprising a plurality of guide vanes, each guide vane comprising a platform with a guide surface and a profiled part extending radially from the guide surface of the platform, the profiled part having an intrados surface and an extrados surface, and the platform having a first lateral surface and a second lateral surface, and the guide surface of the platform comprising a first guide surface part extending from the intrados surface of the profiled part to the first lateral surface and a second guide surface part extending from the extrados surface from the profiled part to the second lateral surface,
the guide vanes being fixed to the shroud such that the second lateral surface of each guide vane is disposed facing a first lateral surface of an adjacent guide vane of the set of guide vanes, and the first guide surface parts and the second guide surface parts of the platforms delimit a flow path for a gas stream flowing between the profiled parts of the guide vanes,
wherein each guide vane has a first junction line formed at the intersection between the first guide surface part and the first lateral surface, a second junction line formed at the intersection between the second guide surface part and the second lateral surface, a third junction line formed at the intersection between the first guide surface part and the intrados surface, and a fourth junction line formed at the intersection between the second guide surface part and the extrados surface,
and wherein the first junction line has a first radius measured from the central axis, in a plane transverse to the central axis, the second junction line has a second radius measured from the central axis, in the plane transverse to the central axis, the second radius being greater than the first radius, such that a portion of the second lateral surface extends into the gas stream by forming a wall preventing parasitic circulation of part of the gas stream from the intrados surface of a guide vane to the extrados surface of an adjacent guide vane, the third junction line has a third radius measured from the central axis, in the plane transverse to the central axis, and the fourth junction line has a fourth radius measured from the central axis, in the plane transverse to the central axis, the fourth radius being equal to the third radius and a difference between the second radius and the fourth radius being equal to a difference between the third radius and the first radius.

29. The assembly according to claim 28, wherein the guide vanes of the set of guide vanes are identical to each other.

30. The assembly according to claim 28, wherein the shroud is an inner straightener shroud and the guide surfaces of the platforms of the guide vanes form an inner wall of the gas stream flow duct.

31. The assembly according to claim 28, wherein the shroud is an outer straightener shroud and the guide surfaces of the platforms of the guide vanes form an outer wall of a gas stream flow duct.

32. The assembly according to claim 28, wherein the assembly is a compressor stator straightener assembly or a turbine stator straightener assembly or a fan straightener assembly.

33. A gas turbine engine comprising an assembly according to claim 28.
